(19) United States
(12) Patent Application Publication
(10) Pub. No.: US 2026/0226323 A1
(43) Pub. Date: Aug. 6, 2026

(54) PRESSURE SENSITIVE ADHESIVE COMPOSITION HAVING IMPROVED HEAT-STABILITY AND USE THEREOF

(71) Applicant: SIKA TECHNOLOGY AG, Baar (CH)

(72) Inventors: Markus MAZUROWSKI, Ginsheim (DE); Jan SPENGLER, Breuberg (DE)

(73) Assignee: SIKA TECHNOLOGY AG, Baar (CH)

(21) Appl. No.: 19/146,341

(22) PCT Filed: Dec. 12, 2023
(86) PCT No.: PCT/EP2023/085368

§ 371 Date: Jul. 8, 2025

(30) Foreign Application Priority Data
Jan. 9, 2023 (EP) 23150818.5

(51) Int. Cl. C09J 123/20; B60R 13/08; C09J 5/00; C09J 11/08; F16F 1/36

(52) U.S. Cl. CPC C09J 123/20; B60R 13/08; C09J 5/00; C09J 11/08; C09J 2203/354; F16F 1/3605; F16F 2226/042; F16F 2228/007

(57) ABSTRACT

A radiation curable adhesive composition including: a) At least one styrene-based polymer, b) At least one tackifying resin, c) At least one photoinitiator, and d) At least one crosslinking agent, wherein the at least one photoinitiator can be activated with irradiation having a wavelength of 365-500 nm, to initiate the curing reactions of the adhesive composition.

### TECHNICAL FIELD

The invention relates to pressure sensitive adhesive compositions, particularly hot-melt pressure sensitive adhesive compositions, and use of them for providing self-adhering vibration and noise damping elements.

### BACKGROUND OF THE INVENTION

Damping materials are widely used in automotive, home appliance, and general industries for reducing undesired vibrations, structure borne noise, and air borne noise. For example, in automotive vehicles, it is desirable to prevent transfer of vibrations generated by the motors, pumps, gears and other dynamic force generators through the body of the vehicle into the passenger compartment. Structure borne noise is produced when the vibrations generated by a dynamic force generator are transmitted through a supporting structure, typically a frame or other hollow structure, to a noise emitting surface, such as a metallic or plastic panel, which transforms the mechanical vibrations into sound waves. Structure borne noise and vibrations in general can be effectively reduced by application of damping materials directly to the structures and surfaces of components subjected to vibrational disturbances, such as to surfaces of vehicle panels, floors, and to shells of articles of home appliance and general industry, for example, machines, washers, and dryers.

Damping materials used for damping of vibrating surfaces are commonly provided as prefabricated single- and multi-layer damping elements or as liquid compositions, which are applied directly on surface of a substrate. Prefabricated damping elements typically comprise a layer of damping material, which is in direct contact with a surface of the substrate to be damped against vibrational disturbances. The layer of damping material is capable of dissipating kinetic energy of the vibrating surface into heat energy through extension and compression of the material of the damping layer. Commonly used damping materials include highly filled compositions comprising bitumen, elastomers, or thermoplastic polymers and varying amounts of additives, such as plasticizers, processing aids, rheology modifiers, and drying agents. Fillers are added to these compositions to meet different design goals. Some of the fillers are used to improve the acoustic damping properties, whereas other fillers are used to reduce the density of the material or to replace more expensive materials in order to reduce costs of raw materials. Liquid applied damping systems are typically thermally drying, gelling, or reactive compositions, which are applied on the surface of the substrate in liquid state, for example by spraying.

Damping elements can further comprise an adhesive layer, such as a layer of a hot-melt or pressure sensitive adhesive, to enable bonding of the damping element to a surface. Hot-melt adhesives are one-component, water- and solvent-free adhesives, which are solid at room temperature. These are applied as a melt and the adhesive bond is established by solidifying on cooling. Pressure sensitive adhesives (PSA) are viscoelastic materials, which adhere immediately to almost any kind of substrates by application of light pressure and which are permanently tacky. Pressure sensitive adhesives that are applied as a melt are known as hot-melt pressure sensitive adhesives (HM-PSA). Due to the permanent tackiness of the adhesive material, layers of pressure sensitive adhesive are usually covered with a release liner to avoid unwanted bonding and to protect the adhesive layer from fouling.

Non-reactive HM-PSA compositions have the disadvantage of exhibiting a relatively poor heat-stability due to the non-crosslinked structure of the cured adhesive. This is a significant disadvantage in some automotive applications, where adhesively bonded structures run through several oven processes under high temperatures. Chemically crosslinked HM-PSA compositions have high heat-stability, but they tend to have poor adhesion to oiled substrates, particularly oiled metal substrates.

There is thus a need for a HM-PSA composition having an improved heat stability and good bonding to oiled substrates. Such adhesive compositions are especially suitable for use in providing vibration and noise damping elements, especially for automotive vehicles.

### SUMMARY OF THE INVENTION

The objective of the present invention is to provide a pressure sensitive adhesive composition having improved heat-stability and good bonding to oiled substrates, particularly oiled metal substrates.

It has been surprisingly found out that the features of claim 1 achieve this object.

The subject of the present invention is related to a radiation curable adhesive composition comprising:
a) At least one styrene-based polymer SC,
b) At least one tackifying resin TR,
c) At least one photoinitiator PI, and
d) At least one crosslinking agent CA,
wherein the at least one photoinitiator PI can be activated with irradiation having a wavelength of 365-500 nm to initiate the curing reactions of the adhesive composition.

Other aspects of the invention are presented in further independent claims. Preferred embodiments are outlined throughout the description and the dependent claims.

### BRIEF DESCRIPTION OF THE DRAWINGS

FIG. 1 shows a cross-section of a vibration and noise damping element (1) comprising a damping layer (2) having a first surface (3) and a second surface (3′), and an adhesive layer (4) covering the first surface (3) of the damping layer (2).

FIG. 2 shows a cross-section of a vibration damped system comprising a substrate (6) having a noise emitting surface (7) and a vibration and noise damping element (1) comprising a damping layer (2) and an adhesive layer (4), wherein a first surface (3) of the damping layer (2) is adhesively bonded to the noise emitting surface (7) via the adhesive layer (4).

### DETAILED DESCRIPTION OF THE INVENTION

A first subject of the present invention is a radiation curable adhesive composition comprising:
a) At least one styrene-based polymer SP,
b) At least one tackifying resin TR,
c) At least one photoinitiator PI, and
d) At least one crosslinking agent CA,
wherein the at least one photoinitiator PI can be activated with irradiation having a wavelength of 365-500 nm to initiate the curing reactions of the radiation curable adhesive composition.

The term “polymer” designates a collective of chemically uniform macromolecules produced by a polyreaction (polymerization, polyaddition, polycondensation) where the macromolecules differ with respect to their degree of polymerization, molecular weight and chain length. The term also comprises derivatives of said collective of macromolecules resulting from polyreactions, that is, compounds which are obtained by reactions such as, for example, additions or substitutions, of functional groups in predetermined macromolecules and which may be chemically uniform or chemically non-uniform.

The term “molecular weight” refers to the molar mass (g/mol) of a molecule or a part of a molecule, also referred to as “moiety”. The term “average molecular weight” refers to number average molecular weight (Mₙ) or weight average molecular weight (M_{w}) of an oligomeric or polymeric mixture of molecules or moieties. The molecular weight can be determined by conventional methods, preferably by gel permeation-chromatography (GPC) using polystyrene as standard, styrene-divinylbenzene gel with porosity of 100 Angstrom, 1000 Angstrom and 10000 Angstrom as the column, and depending on the molecule, tetrahydrofurane as a solvent, at 35° C. or 1,2,4-trichlorobenzene as a solvent, at 160° C.

The term “softening point” or “softening temperature” refers to a temperature at which compound softens in a rubber-like state, or a temperature at which the crystalline portion within the compound melts. The softening point can be measured by a Ring and Ball method according to DIN EN 1238:2011 standard.

The “amount or content of at least one component X” in a composition, for example “the amount of the at least one styrene-based polymer” refers to the sum of the individual amounts of all styrene-based polymers contained in the composition. For example, in case the composition comprises 20 wt.-% of at least one styrene-based polymer, the sum of the amounts of all styrene-based polymer contained in the composition equals 20 wt.-%.

The term “photoinitiator” refers compounds that when exposed to UV or visible radiation create reactive species, for example, free radicals, cations, or anions, which initiate chemical reactions, such as polymerization and/or curing reactions.

According to one or more embodiments, the at least one photoinitiator PI can be activated with irradiation having a wavelength of 365-475 nm, preferably 365-450 nm, more preferably 365-415 nm, to initiate the curing reactions of the radiation curable adhesive composition. According to one or more further embodiments, the at least one photoinitiator PI can be activated with irradiation having a wavelength of 375-485 nm, preferably 380-475 nm, more preferably 385-465 nm, even more preferably 390-450 nm to initiate the curing reactions of the radiation curable adhesive composition. The term “curing” refers here to chemical reactions comprising forming of bonds resulting, for example, in chain extension and/or crosslinking of polymer chains.

Radiation curable adhesive compositions comprising a photoinitiator that can be activated with irradiation having a wavelength falling within the above cited ranges can be cured by using visible light instead of only UV-radiation, which enables application of the adhesive compositions using simplified and safer processes.

Suitable compounds for use as the at least one photoinitiator PI include, for example, 2,4,6-trimethylbenzoyldiphenylphosphine oxide (TPO), 2,4,6-trimethylbenzoylethoxyphenylphosphine oxide (TPO-L), bis(2,4,6-trimethylbenzoyl)phenylphosphine oxide (BAPO), bis(cyclopentadienyl) bis(2,6-difluoro-3-(1H-pyrro; 1-(2,4-Difluorophenyl)-1H-pyrrole titanium complex, polybutyleneglycol bis(9-oxo-9H-thioxanthenyloxy)acetate (TX), 2-isopropylthioxanthone (ITX), 1-chloro-4-propoxythioxanthone (CPTX), camphorquinone (CQ), bis-(2,6-dimethoxybenzoyl)-2,4,4-trimethylpentylphosphine oxide, and 2-benzyl-2-(dimethylamino)-4-morpholino-butyrophenone (DBMP).

Suitable photoinitiators are commercially available, for example, under the trade names of Omnirad® 819, Omnirad® TPO, Omnirad® TP, Omnirad® ITX, Omnirad® DETX, Esacure® 3644, Omnirad® EMK, Omnirad® 2100, Omnirad® BL 750, Omnipol® TX, and Omnipol® BL 728 (all from IGM Resins).

The radiation curable adhesive composition comprises, in addition to the photoinitiator PI, at least one crosslinking agent CA.

According to one or more preferred embodiments, the at least one crosslinking agent CA has at least two thiol groups, preferably at least three thiol groups, more preferably at least four thiol groups. The term “thiol group” refers here to a sulfhydryl group having a general formula —SH.

According to one or more embodiments, the at least one crosslinking agent CA has a number average molecular weight (Mₙ) determined by gel permeation-chromatography using polystyrene as standard of 150-1500 g/mol, preferably 350-1000 g/mol, more preferably 450-850 g/mol.

According to one or more embodiments, the at least one crosslinking agent CA has at least three thiol groups, preferably at least four thiol groups and/or a number average molecular weight (Mₙ) determined by gel permeation-chromatography using polystyrene as standard of not more than 1000 g/mol, preferably of 350-1000 g/mol, more preferably 450-850 g/mol. Such crosslinking agents CA have been found out to enable providing radiation curable adhesive compositions exhibiting particularly short curing times, which may be advantageous in some applications.

Preferably, the amount of the at least one styrene-based polymer SP makes up not more than 50 wt.-%, preferably not more than 45 wt.-%, more preferably not more than 40 wt.-% of the total weight of the radiation curable adhesive composition.

According to one or more embodiments, the radiation curable adhesive composition comprises 10-50 wt.-%, preferably 15-40 wt. %, more preferably 20-35 wt.-%, based on the total weight of the adhesive composition, of the at least one styrene-based polymer SP.

According to one or more embodiments, the radiation curable adhesive composition comprises:
a) 10-50 wt.-%, preferably 15-40 wt. %, more preferably 20-35 wt.-% of the at least one styrene-based polymer SP,
b) 15-65 wt.-%, preferably 25-60 wt.-%, more preferably 30-55 wt.-% of he at least one tackifying resin TR,
c) 0.25-5 wt.-%, preferably 0.5-3.5 wt.-%, more preferably 0.75-2.5 wt.-% of the at least one photoinitiator PI, and
d) 0.05-5 wt.-%, preferably 0.25-3.5 wt.-%, more preferably 0.5-2.5 wt.-% of the at least one crosslinking agent CA, all proportions being based on the total weight of the adhesive composition.

Suitable compounds for use the styrene-based polymer SP include, for example, styrene block copolymers and styrene-butadiene rubbers (SBR).

Suitable styrene block copolymers include block copolymers of the SXS type, in each of which S denotes a non-elastomer styrene (or polystyrene) block and X denotes an elastomeric α-olefin block, preferably having a glass transition temperature in the range from −55° C. to −35° C. The elastomeric α-olefin block may also be a chemically modified α-olefin block.

According to one or more embodiments, the at least one styrene-based polymer SP is selected from styrene-isoprene-styrene (SIS) block copolymer, styrene-butadiene-styrene (SBS) block copolymer, styrene-isoprene-butadiene-styrene block copolymer (SIBS), and styrene-butadiene rubber (SBR).

According to one or more embodiments, the at least one styrene-based polymer SP comprises at least one styrene-isoprene-styrene (SIS) block copolymer SP1 and/or styrene-butadiene-styrene (SBS) block copolymer SP2, preferably having:
a styrene content of not more than 60 wt.-%, preferably not more than 55 wt.-%, more preferably not more than 50 wt.-%, even more preferably not more than 45 wt.-% and/or
a melt flow rate determined according to ASTM D1238 (200° C./5 kg) of not more than 100 g/10 min, more preferably not more than 75 g/10 min, even more preferably not more than 50 g/10 min, still more preferably not more than 30 g/10 min.

Generally, the expression “the at least one component X comprises at least one component XN”, such as “the at least one styrene-based polymer SP comprises at least one styrene-isoprene-styrene block copolymer SP1” is understood to mean in the context of the present disclosure that the adhesive composition comprises one or more styrene-isoprene-styrene block copolymers SP1 as representatives of the at least one styrene block copolymer SP.

The term “styrene content of a block copolymer” refers to a weight percentage of styrene or polystyrene in the block copolymer and is based on the total weight of the block copolymer. The terms styrene content and polystyrene content can be used interchangeably. Preferred SIS and SBS block copolymers to be used as the at least one styrene-based polymer SP have a linear, radial, or a star-shaped structure.

Suitable SIS block copolymers having a styrene content of not more than 45 wt.-% are commercially available, for example, under the trade name of Kraton®, for example Kraton® D-1111P, Kraton® D-1114P, Kraton® D-1117P, Kraton® D-1119P, Kraton® D-1161P, Kraton® D-1193P (all from Kraton Performance Polymers) and under the trade name of Vector®, such as Vector® 4000-series SIS (from TSRC/Dexco).

According to one or more embodiments, the radiation curable adhesive composition comprises the at least one styrene-isoprene-styrene (SIS) block copolymer SP1 and/or the at least one styrene-butadiene-styrene (SBS) block copolymer SP2, wherein the weight ratio of the amount of SP1 to SP2 in the adhesive composition is in the range of from 3:1 to 1:5, preferably from 2:1 to 1:3, more preferably from 1.5:1 to 1:2.5.

The radiation curable adhesive composition further comprises at least one tackifying resin TR.

The term “tackifying resin” designates in the present document resins that in general enhance the adhesion and/or tackiness of an adhesive composition. The term “tackiness” designates in the present document the property of a substance of being sticky or adhesive by simple contact. The tackiness can be measured, for example, as a loop tack. Preferred tackifying resins are tackifying at a temperature of 25° C.

Examples of suitable tackifying resins include natural resins, synthetic resins and chemically modified natural resins.

Examples of suitable natural resins and chemically modified natural resins include rosins, rosin esters, phenolic modified rosin esters, and terpene resins. The term “rosin” is to be understood to include gum rosin, wood rosin, tall oil rosin, distilled rosin, and modified rosins, for example dimerized, hydrogenated, maleated and/or polymerized versions of any of these rosins.

Suitable terpene resins include copolymers and terpolymers of natural terpenes, such as styrene/terpene and alpha methyl styrene/terpene resins; polyterpene resins generally resulting from the polymerization of terpene hydrocarbons, such as the bicyclic monoterpene known as pinene, in the presence of Friedel-Crafts catalysts at moderately low temperatures; hydrogenated polyterpene resins; and phenolic modified terpene resins including hydrogenated derivatives thereof.

The term “synthetic resin” refers to compounds obtained from the controlled chemical reactions such as polyaddition or polycondensation between well-defined reactants that do not themselves have the characteristic of resins. Monomers that may be polymerized to synthesize the synthetic resins may include aliphatic monomer, cycloaliphatic monomer, aromatic monomer, or mixtures thereof. Aliphatic monomers can include C₄, C₅, and C₆ paraffins, olefins, and conjugated diolefins. Examples of aliphatic monomer or cycloaliphatic monomer include butadiene, isobutylene, 1,3-pentadiene, 1,4-pentadiene, cyclopentane, 1-pentene, 2-pentene, 2-methyl-1-pentene, 2-methyl-2-butene, 2-methyl-2-pentene, isoprene, cyclohexane, 1-3-hexadiene, 1-4-hexadiene, cyclopentadiene, dicyclopentadiene, and terpenes. Aromatic monomer can include C₈, C₉, and C₁₀ aromatic monomer. Examples of aromatic monomer include styrene, indene, derivatives of styrene, derivatives of indene, coumarone and combinations thereof.

Particularly suitable synthetic resins include synthetic hydrocarbon resins made by polymerizing mixtures of unsaturated monomers that are obtained as by-products of cracking of natural gas liquids, gas oil, or petroleum naphthas. Synthetic hydrocarbon resins obtained from petroleum-based feedstocks are referred in the present document as “hydrocarbon resins”. These include also pure monomer aromatic resins, which are made by polymerizing aromatic monomer feedstocks that have been purified to eliminate color causing contaminants and to precisely control the composition of the product. Hydrocarbon resins typically have a relatively low average molecular weight (Mₙ), such in the range of 250-5000 g/mol and a glass transition temperature of above 0° C., preferably equal to or higher than 15° C., more preferably equal to or higher than 30° C.

Examples of suitable hydrocarbon resins include C5 aliphatic hydrocarbon resins, mixed C5/C9 aliphatic/aromatic hydrocarbon resins, aromatic modified C5 aliphatic hydrocarbon resins, cycloaliphatic hydrocarbon resins, mixed C5 aliphatic/cycloaliphatic hydrocarbon resins, mixed C9 aromatic/cycloaliphatic hydrocarbon resins, mixed C5 aliphatic/cycloaliphatic/C9 aromatic hydrocarbon resins, aromatic modified cycloaliphatic hydrocarbon resins, C9 aromatic hydrocarbon resins, polyterpene resins, and copolymers and terpolymers of natural terpenes as well hydrogenated versions of the aforementioned hydrocarbon resins. The notations “C5” and “C9” indicate that the monomers from which the resins are made are predominantly hydrocarbons having 4-6 and 8-10 carbon atoms, respectively. The term “hydrogenated” includes fully, substantially and at least partially hydrogenated resins. Partially hydrogenated resins may have a hydrogenation level, for example, of 50%, 70%, or 90%.

Preferably, the at least one tackifying resin TR is a non-functionalized tackifying resin. The term “non-functionalized tackifying resin” designates tackifying resins which are not chemically modified so as to contain functional groups such as epoxy, silane, sulfonate, amide, or anhydride groups.

According to one or more embodiments, the at least one tackifying resin TR has:
a softening point measured by a Ring and Ball method according to DIN EN 1238:2011 standard in the range of 65-185° C., preferably 75-175° C., more preferably 80-170° C. and/or
a number average molecular weight (Mₙ) in the range of 150-5000 g/mol, preferably 250-3500 g/mol, more preferably 250-2500 g/mol and/or
a glass transition temperature (T_{g}) determined by dynamical mechanical analysis (DMA) as the peak of the measured loss modulus (G″) curve using an applied frequency of 1 Hz and a strain level of 0.1% of at or above 0° C., preferably at or above 15° C., more preferably at or above 25° C., even more preferably at or above 30° C., still more preferably at or above 35° C.

Suitable hydrocarbon resins are commercially available, for example, under the trade name of Wingtack® series, Wingtack® Plus, Wingtack® Extra, and Wingtack® STS (all from Cray Valley); under the trade name of Escorez® 1000 series, Escorez® 2000 series, and Escorez® 5000 series (all from Exxon Mobile Chemical); under the trade name of Novares® T series, Novares® TT series, Novares® TD series, Novares® TL series, Novares® TN series, Novares® TK series, and Novares® TV series (all from RUTGERS Novares GmbH); and under the trade name of Kristalex®, Plastolyn®, Piccotex®, Piccolastic® and Endex® (all from Eastman Chemicals).

According to one or more embodiments, the radiation curable adhesive composition further comprises:
e) At least one plasticizer PL, preferably selected from process oils and liquid polyolefin resins.

Suitable process oils for use as the plasticizer PL include at least mineral oils, synthetic oils, and vegetable oils.

The term “mineral oil” refers in the present disclosure hydrocarbon liquids of lubricating viscosity (i.e., a kinematic viscosity at 100° C. of 1 cSt or more) derived from petroleum crude oil and subjected to one or more refining and/or hydroprocessing steps, such as fractionation, hydrocracking, dewaxing, isomerization, and hydrofinishing, to purify and chemically modify the components to achieve a final set of properties. In other words, the term “mineral” refers in the present disclosure to refined mineral oils, which can be also characterized as Group I-III base oils according to the classification of the American Petroleum Institute (API).

Suitable mineral oils to be used as the at least one plasticizer PL include paraffinic, naphthenic, and aromatic mineral oils. Particularly suitable mineral oils include paraffinic and naphtenic oils containing relatively low amounts of aromatic moieties, such as not more than 25 wt.-%, preferably not more than 15 wt.-%, based on the total weight of the mineral oil.

The term “synthetic oil” refers in the present disclosure to full synthetic (polyalphaolefin) oils, which are also known as Group IV base oils according to the classification of the American Petroleum Institute (API). Suitable synthetic oils are produced from liquid polyalphaolefins (PAOs) obtained by polymerizing α-olefins in the presence of a polymerization catalyst, such as a Friedel-Crafts catalyst. In general, liquid PAOs are high purity hydrocarbons with a paraffinic structure and high degree of side-chain branching. Particularly suitable synthetic oils include those obtained from so-called Gas-To-Liquids processes.

The term “liquid polyolefin resin” refers in the present disclosure to a polyolefin resin that flows at normal room temperature, i.e., has a pour point of less than 20° C.

Suitable liquid polyolefin resins to be used as the at least one plasticizer PL include, for example, liquid polybutene and liquid polyisobutylene (PIB). The term “liquid polybutene” refers in the present disclosure to low molecular weight olefin oligomers comprising isobutylene and/or 1-butene and/or 2-butene. The ratio of the C4-olefin isomers can vary by manufacturer and by grade. When the C4-olefin is exclusively 1-butene, the material is referred to as “poly-n-butene” or “PNB”. The term “liquid polyisobutylene” refers in the present document to low molecular weight olefin oligomers of isobutylene, preferably containing at least 75 wt.-%, more preferably at least 85 wt.-% of repeat units derived from isobutylene. Suitable liquid polybutenes and polyisobutylenes have a number average molecular weight (Mₙ) of less than 5000 g/mol, preferably less than 3500 g/mol, more preferably less than 3000 g/mol, even more preferably less than 2500 g/mol.

Suitable liquid polybutenes and polyisobutylenes are commercially available, for example, under the trade name of Indopol®, such as Indopol® H-300 and Indopol® H-1200 (from Ineos); under the trade name of Glissopal®, such as Glissopal® V230, Glissopal® V500, and Glissopal® V700 (from BASF); under the trade name of Dynapak®, such as Dynapak® poly 230 (from Univar GmbH, Germany); and under the trade name of Daelim®, such as Daelim® PB 950 (from Daelim Industrial).

Especially suitable liquid polybutenes and liquid polyisobutylenes have:
an average molecular weight (Mₙ) of 150-3500 g/mol, preferably 250-3000 g/mol, more preferably 350-2500 g/mol and/or
a pour point determined according to ISO 3016 in the range of −10 to +15° C., preferably from −10 to +10° C. and/or
a polydispersity index (M_{w}/Mₙ), determined by GPC, of not more than 5, preferably in the range of 0.5-5.0, more preferably 1.0-4.5, even more preferably 1.0-3.5.

The at least one plasticizer PL, if used, preferably makes up 5-45 wt.-%, more preferably 10-40 wt.-%, even more preferably 15-35 wt.-% of the total weight of the radiation curable adhesive composition.

According to one or more embodiments, the at least one plasticizer PL comprises at least one process oil PL1, preferably a mineral oil, more preferably a paraffinic or naphtenic oil, wherein the at least one process oil PL1 preferably makes up at least 25 wt.-%, more preferably at least 50 wt.-%, even more preferably at least 75 wt.-%, of the total weight of the at least one plasticizer PL.

According to one or more embodiments, the radiation curable adhesive composition comprises both the at least one tackifying resin TR and the at least one plasticizer PL, preferably comprising the at least one process oil PL1, preferably a mineral oil, more preferably a paraffinic or naphtenic oil, wherein the weight ratio of the at least one tackifying resin TR to the at least one process oil PL1 is in the range of 3:1 to 1:1, preferably 2.5:1 to 1:1.

According to one or more embodiments, the radiation curable adhesive composition further comprises:
f) At least one liquid rubber LR different from the at least one plasticizer PL.

The term “liquid rubber” refers in present disclosure a polymer showing a rubber phase or a rubber that is present in a liquid phase at room temperature (23° C.±3° C.). Here, the “liquid phase” means that a rubber shows fluidity as a rubber itself from which a solvent has been removed.

Suitable liquid rubbers include homopolymer and copolymers having at least one olefinically unsaturated double bond per molecule, for example, polybutadienes, especially 1,4- and 1,2-polybutadienes, polybutenes, polyisobutylenes, 1,4- and 3,4-polyisoprenes, styrene/butadiene copolymers, butadiene/acrylonitrile copolymers, optionally having terminal and/or (randomly distributed) lateral functional groups, such as maleic anhydride, hydroxyl, or silane groups.

Especially suitable liquid rubbers have:
a number average molecular weight (Mₙ) of 5000-150000 g/mol, preferably 8000-130000 g/mol, more preferably 12000-100000 g/mol, even more preferably 15000-80000 g/mol and/or
glass transition temperature measured by DSC of at or below 20° C., preferably at or below 10° C., more preferably at or below 0° C. and/or
a viscosity at 23° C. measured according to EN ISO 3219 standard of 2.5-2700 Pa s, preferably 5-2000 Pa s, more preferably 10-15000 Pa s.

Suitable liquid rubbers for use in the radiation curable adhesive composition are commercially available, for example, from Kuraray under the trade name of LIR®-, LBR®-, and L-SBR®-series, for example, LIR-30, LIR-50, LIR-200, LIR-300-series, LIR-400-series, LIR-700, LBR-300-series, and L-SBR-800 series. Further suitable liquid rubbers are commercially available from Synthomer under the trade name of Lithene®, from Nippon-Soda under the trade name of NISSO-PB®, from Cray Valley under the trade name of Ricon®, and from Evonik Industries under the trade name of Polyvest®.

The at least one liquid rubber LR, if used, is preferably makes up 0.5-25 wt.-%, more preferably 1.5-20 wt.-%, even more preferably 2.5-15 wt.-% of the total weight of the radiation curable adhesive composition.

Furthermore, the radiation curable adhesive composition can contain additional auxiliary substances and additives, for example, those selected from the group consisting of UV absorption agents, UV and heat stabilizers, optical brighteners, pigments, dyes, and desiccants. Exemplary UV stabilizers that can be included in the hot melt adhesive composition include, for example, sterically hindered phenols. However, the total amount of such additional auxiliary substances and additives preferably makes up not more than 15 wt.-%, more preferably not more than 10 wt.-%, even more preferably not more than 5 wt.-%, of the total weight of the radiation curable adhesive composition.

The radiation curable adhesive composition can be prepared by mixing its constituents at a temperature of 140-220° C., preferably 160-200° C., until a homogeneously mixed mixture is obtained.

Any conventional mixing technique known to those skilled in the art may be used. Preferably, the mixing is conducted by using a kneading process. The components a) to d) and the optional components e) and f), if used, can be added to the mixer in any order. Preferably, the at least one styrene-based polymer SP is first mixed with the tackifying resins TR until a homogeneously mixed mixture is obtained. The rest of the constituents can then be added to the homogeneously mixed mixture of in any order.

The preferences given above for the at least one styrene-based polymer SP, the at least one tackifying resin TR, the at least one photoinitiator PI, the at least one crosslinking agent CA, the at least one plasticizer PL, and to the at least one liquid rubber LR apply equally for all subjects of the present invention unless stated otherwise.

Another aspect of the present invention is an at least partially cured adhesive obtained by subjecting a mass of the radiation curable adhesive composition of the present invention to radiation having a wavelength in the range of 365-500 nm, preferably 365-475 nm, more preferably 365-450 nm, even more preferably 365-415 nm, to initiate the curing reactions of the radiation curable adhesive composition.

In one or more embodiments, the mass of the radiation curable adhesive composition is subjected to radiation having a wavelength in the range of 375-485 nm, preferably 380-475 nm, more preferably 385-465 nm, even more preferably 390-450 nm to initiate the curing reactions of the radiation curable adhesive composition

A further aspect of the present invention is a method for producing an at least partially cured adhesive comprising steps of:
providing a mass of the radiation curable adhesive composition of the present invention and
subjecting the mass to radiation having a wavelength in the range of 365-500 nm, preferably 365-475 nm.

In one or more embodiments, the mass of the radiation curable adhesive composition is subjected to radiation having a wavelength in the range of 375-485 nm, preferably 380-475 nm, more preferably 385-465 nm, even more preferably 390-450 nm, to initiate the curing reactions of the radiation curable adhesive composition.

A further aspect of the present invention is a vibration and noise damping element (1) comprising:
i) A damping layer (2) having a first surface (3) and a second surface (3′) and,
ii) An adhesive layer (4) composed of the at least partially cured adhesive of the present invention and covering at least a portion of the first surface (3) of the damping layer (2),
wherein the damping layer (2) comprises or is composed of an acoustic damping material comprising:
A bitumen component BC or a polymer component PC,
At least one hydrocarbon resin HR,
Optionally at least one wax W,
Optionally at least one plasticizer PL, and
At least 25 wt.-%, preferably at least 35 wt.-%, based on the total weight of the acoustic damping material, of at least one solid particulate filler F.

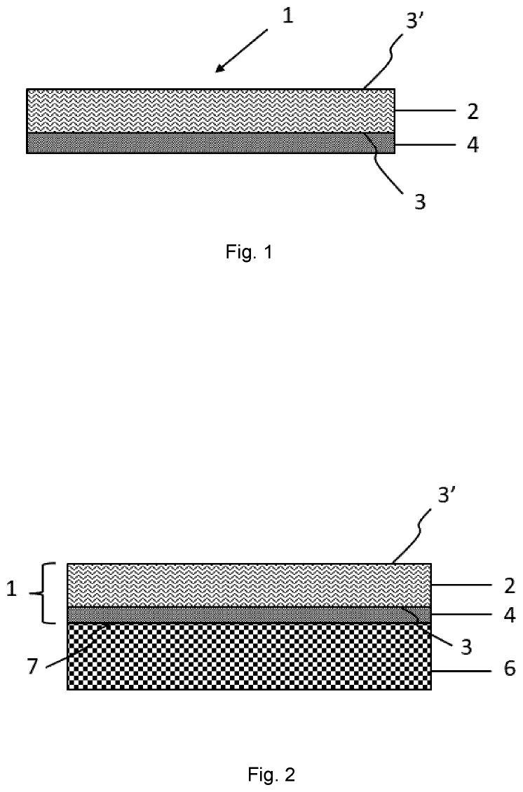

A cross-section of the vibration and noise damping element (1) is shown in FIG. 1.

The bitumen component BC or the polymer component PC and the various additives including the at least one hydrocarbon resin HR, the at least one wax W, and the at least one plasticizer PL, if present in the acoustic damping material, form a binder matrix for the at least one solid particulate filler F. The amount of the binder matrix in the acoustic damping material is not particularly restricted but its amount should be high enough to enable efficient binding of the constituents of the filler component and to prevent formation of interconnected solid networks of the solid particulate compounds.

The acoustic damping material comprises at least 25 wt.-%, preferably at least 35 wt.-%, more preferably at least 45 wt.-%, based on the total weight of the acoustic damping material, of the at least one solid particulate filler F.

According to one or more embodiments, the acoustic damping material comprises 25-75 wt.-%, preferably 35-70 wt.-%, more preferably 40-70 wt.-%, even more preferably 45-70 wt.-%, still more preferably 45-65 wt.-%, based on the total weight of the acoustic damping material, of the at least one solid particulate filler F.

The at least one solid particulate filler F preferably has a do particle size of not more than 2.5 mm, more preferably not more than 1.5 mm and/or a water-solubility of less than 0.1 g/100 g water, more preferably less than 0.05 g/100 g water, even more preferably less than 0.01 g/100 g water, at a temperature of 20° C.

The term “particle size” refers in the present disclosure to the area-equivalent spherical diameter of a particle (Xₐᵣₑₐ). The term “median particle size d₅₀” refers to a particle size below which 50% of all particles by volume are smaller than the d₅₀ value. In analogy, the term deo particle size refers in the present disclosure to a particle size below which 90% of all particles by volume are smaller than the deo value. A particle size distribution can be measured by laser diffraction according to the method as described in standard ISO 13320:2009 using a wet or dry dispersion method and for example, a Mastersizer 2000 device (trademark of Malvern Instruments Ltd, GB).

According to one or more embodiments, the at least one solid particulate filler F is selected from calcium carbonate, magnesium carbonate, talc, kaolin, diatomaceous earth, wollastonite, feldspar, montmorillonite, dolomite, silica, cristobalite, iron oxide, iron nickel oxide, strontium ferrite, barium-strontium ferrite, hollow ceramic spheres, hollow glass spheres, hollow organic spheres, glass spheres, mica, barium sulfate, and graphite.

It may be preferable that the acoustic damping material comprises several different fillers, such as at least two different fillers. Some of the fillers may, for example, be used for improving the acoustic damping properties of the acoustic damping material whereas other may be used to enable adhering of the acoustic damping material to a metal substrate by magnetic force or for decreasing the weight of the acoustic damping material.

Preferably, the sum of the amounts of the bitumen component BC, the polymer component PC, the at least one hydrocarbon resin HR, the at least one wax W, and the at least one plasticizer PL, if present in the acoustic damping material, makes not more than 70 wt.-%, preferably not more than 65 wt.-%, more preferably not more than 60 wt.-% of the total weight of the acoustic damping material.

According to one or more embodiments, the sum of the amounts of the bitumen component BC, the polymer component PC, the at least one hydrocarbon resin HR, the at least one wax W, and the at least one plasticizer PL, if present in the acoustic damping material, makes up 15-65 wt.-%, preferably 20-60 wt.-%, more preferably 20-55 wt.-%, even more preferably 25-50, most preferably 25-45 wt.-%, of the total weight of the acoustic damping material.

Examples of suitable hydrocarbon resins to be used as the at least one hydrocarbon resin HR include C5 aliphatic resins, mixed C5/C9 aliphatic/aromatic resins, aromatic modified C5 aliphatic resins, cycloaliphatic resins, mixed C5 aliphatic/cycloaliphatic resins, mixed C9 aromatic/cycloaliphatic resins, mixed C5 aliphatic/cycloaliphatic/C9 aromatic resins, aromatic modified cycloaliphatic resins, C9 aromatic resins, as well hydrogenated versions of the aforementioned resins. The notations “C5” and “C9” indicate that the monomers from which the resins are made are predominantly hydrocarbons having 4-6 and 8-10 carbon atoms, respectively. The term “hydrogenated” includes fully, substantially, and at least partially hydrogenated resins. Partially hydrogenated resins may have a hydrogenation level, for example, of 50%, 70%, or 90%.

The type of the at least one hydrocarbon resin HR is not particularly restricted in the present invention. The selection of the at least one hydrocarbon resin HR depends, at least partially, on the type of the other components contained in the binder matrix of the acoustic damping material, particularly of the type of the polymer component PC.

According to one or more embodiments, the at least one hydrocarbon resin HR has:
a softening point determined by using the Ring and Ball method as defined in DIN EN 1238:2011 standard of at least 70° C., preferably at least 80° C., more preferably in the range of 70-180° C., preferably 80-170° C., more preferably 100-160° C. and/or
an average molecular weight (Mₙ) in the range of 250-7500 g/mol, preferably 300-5000 g/mol and/or
a glass transition temperature (T_{g}) determined by dynamical mechanical analysis (DMA) as the peak of the measured loss modulus (G″) curve using an applied frequency of 1 Hz and a strain level of 0.1% of at or above 0° C., preferably at or above 15° C., more preferably at or above 35° C., even more preferably at or above 55° C., still more preferably at or above 65° C., most preferably at or above 75° C.

Suitable hydrocarbon resins are commercially available, for example, under the trade name of Wingtack® series, Wingtack® Plus, Wingtack® Extra, and Wingtack® STS (all from Cray Valley); under the trade name of Escorez® 1000 series, Escorez® 2000 series, and Escorez® 5000 series (all from Exxon Mobile Chemical); under the trade name of Novares® T series, Novares® TT series, Novares® TD series, Novares® TL series, Novares® TN series, Novares® TK series, and Novares® TV series (all from RUTGERS Novares GmbH); and under the trade name of Kristalex®, Plastolyn®, Piccotex®, Piccolastic® and Endex® (all from Eastman Chemicals).

According to one or more embodiments, the acoustic damping material further comprises at least one wax W.

The term “wax” designates in the present document substances that have a waxy consistency and have a melting temperature or melting temperature range of above normal room temperature, in particular above 25° C.

Suitable waxes to be used as the at least one wax include particularly synthetic waxes, for example, petroleum waxes, such as paraffin wax, petrolatum, and microcrystalline waxes, polyolefin waxes, polyethylene glycol waxes (Carbowax), amide waxes, and chemically modified waxes, such as hardened or hydrogenated waxes, for example, Montan ester waxes.

According to one or more embodiments, the at least one wax W is selected from the group consisting of polyolefin waxes, paraffin waxes, microcrystalline waxes, and amide waxes.

According to one or more embodiments, the at least one wax W has:
a softening point determined by using the Ring and Ball method as defined in DIN EN 1238:2011 standard in the range of 75-180° C., preferably 80-160° C., more preferably 85-140° C. and/or
a melt viscosity at a temperature of 170° C. determined according to DIN 53019-1:2008 standard in the range of 10-10000 mPa·s, preferably 100 to 5000 mPa·s, more preferably 500-3500 mPa·s. The melt viscosity can be determined by busing a rotational viscometer at 5 revolutions per minute, for example by using a Brookfield DV-2 Thermosel viscometer with a spindle No. 27.

According to one or more embodiments, the at least one wax is a polyolefin wax. The term “polyolefin wax” designates in the present document low molecular weight polymers of linear or branched α-olefins having from 2 to 30 carbon atoms and a number average molecular weight (Mₙ) in the range of 5000-25000 g/mol. They include both homopolymers and copolymers of the above mentioned linear or branched α-olefins. Polyolefin waxes can be obtained by thermal decomposition of polyolefin plastics, in particular polyethylene plastic, or by direct polymerization of olefins. Suitable polymerization processes include, for example, free-radical processes, where the olefins, for example, ethylene, are reacted at high pressures and temperatures to give more or less branched waxes and processes, where ethylene and/or higher α-olefins, in particular propylene, are polymerized using metalorganic catalysts, for example Ziegler-Natta or metallocene catalysts, to give unbranched or branched waxes. The polyolefin waxes have generally at least partially crystalline structure.

According to one or more embodiments, the at least one wax W is a paraffin wax, preferably a Fischer-Tropsch wax. The term “paraffin wax” designates in the present disclosure hard, crystalline wax composed mainly of saturated paraffin hydrocarbons. The paraffin waxes are typically obtained from petroleum distillates or derived from mineral oils of the mixed-base or paraffin-base type.

According to one or more embodiments, the at least one wax W is an amide wax. The term “amide wax” designates in the present document waxes containing an amide bond (—CONH—) in the molecule or an amide group (—CONH₂) at the end of the molecule. According to one or more embodiments, the at least one wax W is an amide wax selected from the group consisting of N,N′-ethylenebis(stearoamide), stearic acid amide, N,N′-methylenebis(stearoamide), and methylolstearoamide.

According to a first preferred embodiment, the acoustic damping material of the damping layer (2) comprises:
b1) 25-65 wt.-%, preferably 35-55 wt.-%, of the bitumen component BC,
b2) 0-10 wt.-%, preferably 0.25-5 wt.-% of the at least one hydrocarbon resin HR, and
b3) 0-10 wt.-%, preferably 0.25-7.5 wt.-% of the at least one wax W, all proportions being based on the total weight of the acoustic damping material.

Acoustic damping materials according to the first preferred embodiment can be characterized as “bitumen-based damping materials”.

The term “bitumen” designates in the present disclosure blends of heavy hydrocarbons, having a solid consistency at room temperature. These are normally obtained as vacuum residue from refinery processes, which can be distillation (topping or vacuum) and/or conversion processes, such as thermal cracking and visbreaking, of suitable crude oils. Furthermore, the term “bitumen” also designates natural and synthetic bitumen as well as bituminous materials obtained from the extraction of tars and bituminous sands.

The bitumen component BC can comprise one of more different types of bitumen materials, such as penetration grade (distillation) bitumen, air-rectified (semi-blown) bitumen, and hard grade bitumen.

The term “penetration grade bitumen” refers here to bitumen obtained from fractional distillation of crude oil. A heavy fraction composed of high molecular weight hydrocarbons, also known as long residue, which is obtained after removal of gasoline, kerosene, and gas oil fractions, is first distilled in a vacuum distillation column to produce more gas oil, distillates, and a short residue. The short residue is then used as a feed stock for producing different grades of bitumen classified by their penetration index, typically defined by a PEN value, which is the distance in tenth millimeters (dmm) that a needle penetrates the bitumen under a standard test method. Penetration grade bitumen are characterized by penetration and softening point. The term “air-rectified bitumen” or “air-refined bitumen” refers in the present disclosure to a bitumen that has been subjected to mild oxidation with the goal of producing a bitumen that meets paving-grade bitumen specifications. The term “hard grade bitumen” refers in the present disclosure to bitumen produced using extended vacuum distillation with some air rectification from propane-precipitated bitumen. Hard bitumen typically has low penetration values and high softening-points.

According to one or more embodiments, the bitumen component BC comprises at least 75 wt.-%, preferably at least 85 wt.-%, more preferably at least 90 wt.-% of at least one penetration grade bitumen, preferably having a penetration value in the range of 15-50 dmm, more preferably 20-45 dmm and/or a softening point determined by Ring and Ball measurement conducted according to DIN EN 1238:2011 standard in the range of 40-125° C., preferably 50-100° C.

In case of a bitumen-based damping material, the acoustic damping material preferably further comprises at least one modifying polymer MP for the bitumen component BC.

Suitable polymers for use as the at least one modifying polymer MP include, for example, atactic polypropylenes (APP), amorphous polyolefins (APO), styrene block copolymers, and elastomers. The term “amorphous polyolefin” refers polyolefins to having a low crystallinity degree determined by a differential scanning calorimetry (DSC) measurement, such as in the range of 0.001-10 wt.-%, preferably 0.001-5 wt.-%. The crystallinity degree of a polymer can be determined by using the differential scanning calorimetry measurements conducted according to ISO 11357-3:2018 standard to determine the heat of fusion, from which the degree of crystallinity is calculated. Particularly, the term “amorphous polyolefin” designates poly-α-olefins lacking a crystalline melting point (Tₘ) as determined by differential scanning calorimetric (DSC) or equivalent technique.

Suitable amorphous polyolefins for use as the at least one modifying polymer MP include, for example, atactic polypropylene, amorphous propene rich copolymers of propylene and ethylene, amorphous propene rich copolymers of propylene and butene, amorphous propene rich copolymers of propylene and hexene, and amorphous propene rich terpolymers of propylene, ethylene, and butene. The term “propene rich” is understood to mean copolymers and terpolymers having a content of propene derived units of at least 50 wt.-%, preferably at least 65 wt.-%, more preferably at least 70 wt.-%, based on total weight of the copolymer/terpolymer.

Suitable styrene block copolymers for use as the at least one modifying polymer MP include, particularly, block copolymers of the SXS type, in each of which S denotes a non-elastomer styrene (or polystyrene) block and X denotes an elastomeric α-olefin block, which may be polybutadiene, polyisoprene, polyisoprene-polybutadiene, completely or partially hydrogenated polyisoprene (poly ethylene-propylene), or completely or partially hydrogenated polybutadiene (poly ethylene-butylene). The elastomeric α-olefin block preferably has a glass transition temperature in the range from −55° C. to −35° C. The elastomeric α-olefin block may also be a chemically modified α-olefin block. Particularly suitable chemically modified α-olefin blocks include, for example, maleic acid-grafted α-olefin blocks and particularly maleic acid-grafted ethylene-butylene blocks. Preferred styrene block copolymers for use as the at least one modifying polymer MP include SBS, SIS, SIBS, SEBS, and SEPS block copolymers, particularly SBS block copolymer, preferably having a linear, radial, diblock, triblock or star structure.

Suitable elastomers for use as the at least one modifying polymer MP include, for example, styrene-butadiene rubber (SBR), ethylene propylene diene monomer rubber (EPDM), polyisoprene, polybutadiene, natural rubber, polychloroprene rubber, ethylene-propylene rubber (EPR), nitrile rubbers, and acrylic rubbers.

According to one or more embodiments, the at least one modifying polymer MP is selected from the group consisting of atactic polypropylenes (APP), amorphous polyolefins (APO), styrene block copolymers, styrene-butadiene rubber (SBR), ethylene propylene diene monomer rubber (EPDM), polyisoprene, polybutadiene, natural rubber, polychloroprene rubber, ethylene-propylene rubber (EPR), nitrile rubbers, and acrylic rubbers.

According to one or more embodiments, the at least one modifying polymer MP is present in the bitumen-based damping material in an amount of 0.5-10 wt.-%, preferably 1-7.5 wt.-%, based on the total weight of the bitumen-based damping material.

In case of a bitumen-based damping material, it may be preferable that the acoustic damping material is substantially free of cross-linking/curing agents, such as free-radical cross-linking agents, for example peroxides. The phrase “substantially free” is intended to mean that if an amount of a cross-linking agent is found in the acoustic damping material, the amount of said amount is so negligible that the effect of the cross-linking agent cannot be obtained. In other words, the amount of a cross-linking agent found in the acoustic damping material cannot initiate curing of the polymeric components, in particular curing of the at least one modifying polymer MP or can initiate only a substantially negligible amount of cross-linking.

According to one or more embodiments, the bitumen-based damping material contains less than 0.15 wt.-%, preferably less than 0.1 wt.-%, more preferably less than 0.01 wt.-%, even more preferably 0 wt.-%, of cross-linking/curing agents, based on the total weight of the bitumen-based damping material.

According to a second preferred embodiment, the acoustic damping material of the damping layer (2) comprises:
0.5-25 wt.-%, preferably 1.5-20 wt.-% of the polymer component PC comprising at least one thermoplastic polymer TP,
2.5-35 wt.-%, preferably 5-30 wt.-% of the at least one hydrocarbon resin HR,
0-15 wt.-%, preferably 0.5-10 wt.-% of the at least one wax W, and
0-30 wt.-%, preferably 0.5-15 wt.-% of the at least one plasticizer PL, all proportions being based on the total weight of the acoustic damping material.

Acoustic damping materials according to the second preferred embodiment can be characterized as “bitumen-free thermoplastic damping materials”.

In case of a bitumen-free thermoplastic damping material, the polymer component PC comprises at least one thermoplastic polymer TP and the portion of the bitumen component BC in the binder matrix has been replaced by a specific combination of the at least one thermoplastic polymer TP and the at least one hydrocarbon resin HR as well as the at least one wax W and the at least one plasticizer PL, which are optionally added to the binder matrix. The use of such binder matrixes has been found out to enable providing bitumen-free thermoplastic damping materials, which can be processed into shaped articles using conventional thermoplastic processing methods, such as extrusion, calendering, injection molding, and hot-pressing techniques.

According to one or more embodiments, the bitumen-free thermoplastic damping material comprises less than 1 wt.-%, preferably less than 0.5 wt.-%, more preferably less than 0.1 wt.-%, even more preferably less than 0.01 wt.-% of bitumen, based on the total weight of the bitumen-free thermoplastic damping material.

The composition of the polymer component PC of a bitumen-free thermoplastic damping material is preferably selected such that the temperature range at which the maximum vibration damping effect of the damping material coincides with the range of temperatures to which the surface of a substrate to be damped against vibrations is subjected during its use.

Since the ability of polymers to dissipate vibrations to heat energy is at maximum when the polymer is in a transition state between the hard/glassy and soft/rubbery state, preferred thermoplastic polymers TP to be used in the bitumen-free thermoplastic damping material have a glass transition temperature (T_{g}) falling within the intended range of application temperatures. For example, in case the bitumen-free thermoplastic damping material is used for damping of vibrations and noise in structures of automotive vehicles, the application temperatures typically range from −40° C. to 60° C., in particular from −35° C. to 50° C. On the other hand, preferred thermoplastic polymers TP to be used in the polymer component PC have a softening point (Ts) and/or a melting temperature (Tₘ) above the maximum application temperature of the bitumen-free thermoplastic damping material.

According to one or more embodiments, the at least one thermoplastic polymer TP has:
a glass transition temperature (T_{g}) determined by dynamical mechanical analysis (DMA) as the peak of the measured loss modulus (G″) curve using an applied frequency of 1 Hz and a strain level of 0.1% of below 25° C., preferably below 5° C., more preferably below 0° C. and/or
a softening point (Ts) determined by Ring and Ball measurement conducted according to DIN EN 1238:2011 standard of above 35° C., preferably above 45° C., more preferably above 55° C., such as in the range of 35-250° C., preferably 45-200° C., more preferably 55-180° C.

According to one or more embodiments, the polymer component PC is composed of the at least one thermoplastic polymer TP.

In acoustic damping applications it is generally desirable to maximize the broadness of the range of temperatures at which the vibration and noise damping effect of the acoustic damping material is at maximum, in particular the range of temperatures at which the measured loss factor of the damping material has a value of above 0.1. Since the maximum vibration damping effect of thermoplastic polymers typically occurs at a narrow range of temperatures, i.e., when the polymer is in its transition state, it may be preferred that the bitumen-free thermoplastic damping material comprises at least two different thermoplastic polymers having different glass transition temperatures (T_{g}).

It can furthermore be advantageous that the at least two different thermoplastic polymers are not entirely miscible with each other and/or that the at least two different thermoplastic polymers can be mixed with each other to form a semi-compatible polymer blend containing micro-incompatible phases. By the polymers being “entirely miscible” with each other is meant that a polymer blend composed of the at least two thermoplastic polymers has a negative Gibbs free energy and heat of mixing. The polymer blends composed of entirely miscible polymers tend to have one single glass transition temperature (T_{g}) as measured by using dynamic mechanical analysis (DMA).

According to one or more embodiments, the at least one thermoplastic polymer TP comprises:
At least one hard thermoplastic polymer TP1, preferably at least one hard ethylene vinyl acetate copolymer, having a melt flow index (MFI) determined according to ISO 1133 (190° C./2.16 kg) of not more than 50 g/10 min, preferably not more than 35 g/10 min, more preferably not more than 25 g/10 min, even more preferably not more than 15 g/10 min, still more preferably not more than 10 g/10 min and/or having a glass transition temperature (T_{g}) determined by dynamical mechanical analysis (DMA) as the peak of the measured loss modulus (G″) curve using an applied frequency of 1 Hz and a strain level of 0.1% of below 5° C., preferably below 0° C., more preferably below −10° C., even more preferably below −20° C. and/or
At least one soft thermoplastic polymer TP2, preferably at least one soft ethylene vinyl acetate copolymer, having a melt flow index (MFI) determined according to ISO 1133 (190° C./2.16 kg) of at least 75 g/10 min, preferably at least 100 g/10 min, more preferably at least 150 g/10 min, even more preferably at least 200 g/10 min, most preferably at least 250 g/10 min and/or having a glass transition temperature (T_{g}) determined by dynamical mechanical analysis (DMA) as the peak of the measured loss modulus (G″) curve using an applied frequency of 1 Hz and a strain level of 0.1% of below 5° C., preferably below −0° C., more preferably below −10° C., even more preferably below −20° C.

Examples of suitable bitumen-free thermoplastic damping materials for use in the damping element of the present invention are disclosed in a published patent application WO 2021/009241 A1, particularly on pages 9-30 of the patent application.

According to a third preferred embodiment, the acoustic damping material of the damping layer (2) comprises:
0.5-20 wt.-%, preferably 2.5-15 wt.-% of the polymer component PC comprising at least one elastomer E,
0.5-35 wt.-%, preferably 2.5-25 wt.-% of the at least one hydrocarbon resin HR,
0-15 wt.-%, preferably 0.5-10 wt.-% of the at least one wax W, and
0-30 wt.-%, preferably 0.5-25 wt.-% of the at least one plasticizer PL, all proportions being based on the total weight of the acoustic damping material.

Acoustic damping materials according to the third preferred embodiment can be characterized as “bitumen-free elastomeric damping materials”.

According to one or more embodiments, the bitumen-free elastomeric damping material comprises less than 1 wt.-%, preferably less than 0.5 wt.-%, more preferably less than 0.1 wt.-%, even more preferably less than 0.01 wt.-% of bitumen, based on the total weight of the bitumen-free elastomeric damping material.

According to one or more embodiments, the at least one elastomer E is selected from the group consisting of butyl rubber, halogenated butyl rubber, ethylene-propylene diene monomer rubber, natural rubber, chloroprene rubber, synthetic 1,4-cis-polyisoprene, polybutadiene rubber, ethylene-propylene rubber, styrene-butadiene rubber, isoprene-butadiene rubber, styrene-isoprene-butadiene rubber, acrylonitrile-isoprene rubber, and acrylonitrile-butadiene rubber, preferably from the group consisting of butyl rubber, halogenated butyl rubber, ethylene-propylene diene monomer rubber, chloroprene rubber, synthetic 1,4-cis-polyisoprene, polybutadiene rubber, and ethylene-propylene rubber.

The term “butyl rubber” designates in the present document a polymer derived from a monomer mixture containing a major portion of a C4 to C7 monoolefin monomer, preferably an isoolefin monomer and a minor portion, such as not more than 30 wt.-%, of a C4 to C14 multiolefin monomer, preferably a conjugated diolefin. The preferred C4 to C7 monoolefin monomer may be selected from the group consisting of isobutylene, 2-methyl-1-butene, 3-methyl-1-butene, 2-methyl-2-butene, 4-methyl-1-pentene, and mixtures thereof.

The preferred C4 to C14 multiolefin comprises a C4 to C10 conjugated diolefin. The preferred C4 to C10 conjugated diolefin may be selected from the group comprising isoprene, butadiene, 2,4-dimethylbutadiene, piperyline, 3-methyl-1,3-pentadiene, 2,4-hexadiene, 2-neopentyl-1,3-butadiene, 2-methyl-1,5-hexadiene, 2,5-dimethyl-2,4-hexadiene, 2-methyl-1,4-pentadiene, 2-methyl-1,6-heptadiene, cyclopentadiene, methylcyclopentadiene, cyclohexadiene, 1-vinyl-cyclohexadiene and mixtures thereof.

According to one or more embodiments, bitumen-free elastomeric damping material comprises 3-15 wt.-%, preferably 3.5-12.5 wt.-%, more preferably 5-12.5 wt.-%, based on the total weight of the bitumen-free elastomeric damping material, of the at least one elastomer E.

According to one or more embodiments, the polymer component PC comprises, in addition to the at least one elastomer E, at least one thermoplastic polymer TMP, preferably selected from the group consisting of polyolefin homopolymers and copolymers, copolymers of ethylene with vinyl acetate, and thermoplastic olefin elastomers (TPE-O)

The preferences given above for the at least one thermoplastic polymer TP used in the bitumen-free thermoplastic damping material apply also to the at least one thermoplastic polymer TMP used in the bitumen-free elastomeric damping material.

According to one or more embodiments, the weight ratio of the amount of the at least one elastomer E to the amount of the at least one thermoplastic polymer TMP is in the range of 10:1 to 1:3, preferably 5:1 to 1:2, more preferably 5:1 to 1:1.

According to one or more embodiments, the bitumen-free elastomeric damping material further comprises a vulcanization system VS.

A large number of vulcanization systems based on elementary sulfur as well as vulcanization systems not containing elementary sulfur are suitable.

In case a vulcanization system based on elementary sulfur is used, the vulcanization system VS preferably contains pulverulent sulfur, more preferably at least one sulfur compound selected from the group consisting of powdered sulfur, precipitated sulfur, high dispersion sulfur, surface-treated sulfur, and insoluble sulfur.

Preferred vulcanization systems based on elementary sulfur comprise 1-15 wt.-%, more preferably 5-10 wt.-% of pulverulent sulfur, preferably at least one sulfur compound selected from the group consisting of powdered sulfur, precipitated sulfur, high dispersion sulfur, surface-treated sulfur, and insoluble sulfur, based on the total weight of the vulcanization system.

According to one or more embodiments, the vulcanization system VS is a vulcanization system without elementary sulfur.

Preferred vulcanization systems without elementary sulfur comprise at least one vulcanization agent and optionally at least one organic vulcanization accelerator and/or at least one inorganic vulcanization accelerator.

Suitable vulcanization agents for vulcanization systems without elementary sulfur include, for example, organic peroxides, phenolic resins, bisazidoformates, polyfunctional amines, para-quinone dioxime, para-benzoquinone dioxime, para-quinone dioxime dibenzoate, p-nitrosobenzene, dinitrosobenzene, thiuram compounds, bismaleimides, dithiols, zinc oxide as well as vulcanization systems crosslinked with (blocked) diisocyanates.

Suitable organic vulcanization accelerators to be used in vulcanization systems without elementary sulfur include thiocarbamates, dithiocarbamates (in the form of their ammonium or metal salts), xanthogenates, thiuram compounds (monosulfides and disulfides), thiazole compounds, aldehyde-amine accelerators, for example hexamethylenetetramine, and guanidine accelerators.

Suitable inorganic vulcanization accelerators to be used in vulcanization systems without elementary sulfur include, for example, zinc compounds, in particular zinc salts of fatty acids, basic zinc carbonates, and zinc oxide.

According to one or more embodiments, the vulcanization system VS is a vulcanization system without elementary sulfur, preferably containing at least one vulcanization agent selected from the group consisting of para-quinone dioxime, para-benzoquinone dioxime, para-quinone dioxime dibenzoate, p-nitrosobenzene, dinitrosobenzene, and thiuram compounds, preferably from the group consisting of para-quinone dioxime, para-benzoquinone dioxime, para-quinone dioxime dibenzoate, tetramethyl thiuram disulfide (TMTD), and tetrabenzylthiuram disulfide (TBzTD), and preferably further containing at least one organic vulcanization accelerator and/or at least one an inorganic vulcanization accelerator.

According to one or more embodiments, the at least one organic vulcanization accelerator is selected from the group consisting of cyclohexylbenzothiazole sulfonamide, mercaptobenzothiazole sulfide (MBTS), diphenyl guanidine, and zinc dimethyldithiocarbamate.

According to one or more embodiments, the at least one inorganic vulcanization accelerator is selected from the group consisting of zinc salts of fatty acids, basic zinc carbonates, and zinc oxide, more preferably zinc oxide.

According to one or more embodiments, the bitumen-free elastomeric damping material comprises 1-15 wt.-%, more preferably 1-12.5 wt.-%, even more preferably 2-10 wt.-%, most preferably 3.5-10 wt.-%, based on the total weight of the bitumen-free elastomeric damping material, of the vulcanization system VS without elementary sulfur.

The acoustic damping materials as discussed above may optionally contain additives, which are customary for acoustic damping materials. Examples of suitable additives include, for example, pigments, thixotropic agents, thermal stabilizers, drying agents, and flame retardants. These additives, if used at all, preferably make up not more than 25 wt.-%, more preferably not more than 15 wt.-%, even more preferably not more than 10 wt.-%, of the total weight of the acoustic damping material.

According to one or more embodiments, the damping layer (2) of the damping element has a maximum thickness of 0.5-15 mm, preferably 1-10 mm, more preferably 1.5-7.5 mm, even more preferably 1.5-5 mm and/or a mass per unit area of 1-5 kg/m², preferably 1-4.5 kg/m², more preferably 1.5-4.5 kg/m², still more preferably 1.5-3.5 kg/m².

Preferably, the adhesive layer (4) of the damping element has a thickness of at least 50 μm, preferably at least 100 μm, more preferably at least 150 μm, even more preferably at least 200 μm.

Such adhesive layers have been found to provide sufficient bond strength in typical automotive damping applications.

Still another subject of the present invention is a method for producing a vibration and noise damping element, the method comprising steps of:
(i) Providing a damping layer (2) composed of an acoustic damping material as discussed above,
(ii) Providing a film of the radiation curable adhesive composition according to the present invention on a first surface (3) of the damping layer (2),
(iii) Subjecting the adhesive film to radiation having a wavelength in the range of 365-500 nm, 365-475 nm, preferably 365-450 nm, more preferably 365-415 nm to effect at least partial curing of the radiation curable adhesive composition, and
(iv) Optionally cutting the element obtained from step (iii) to pre-determined dimensions, such as length and/or width.

In one or more embodiments, the adhesive film is subjected to radiation having a wavelength in the range of 375-485 nm, preferably 380-475 nm, more preferably 385-465 nm, even more preferably 390-450 nm to effect at least partial curing of the radiation curable adhesive composition.

The damping layer (2) of the damping element can be provided by mixing the constituents of the acoustic damping material at an elevated temperature until a homogeneously mixed mixture is obtained followed by processing the homogeneously mixed mixture into a form of a shaped article.

The term “homogeneously mixed mixture” refers in the present disclosure to compositions, in which the individual constituents are distributed substantially homogeneously in the composition. Furthermore, a homogeneously mixed mixture can be multi-phase mixture. For example, a homogeneously mixed mixture of a polymer component and a filler component, therefore, refers to composition in which the constituents of the filler phase are homogeneously/uniformly distributed in the polymer phase. For a person skilled in the art, it is clear that within such mixed compositions there may be regions formed, which have a slightly higher concentration of one of the constituents than other regions and that a 100% homogeneous distribution of all the constituents is generally not achievable. Such mixed compositions with “imperfect” distribution of constituents, however, are also intended to be included by the term “homogeneously mixed mixture” in accordance with the present invention.

Any conventional type of a mixing apparatus can be used for mixing of the constituents of the acoustic damping material. The mixing step can be conducted as a batch process using a conventional batch-type mixer, such as a Dreis mixer, a Brabender mixer, a Banbury mixer, or a roll mixer or as a continuous process using a continuous-type mixer, such as an extruder, in particular a single-, a twin-screw extruder or a planetary roller extruder. It may be advantageous to heat the constituents before or during mixing, either by applying external heat sources or by friction generated by the mixing process itself, in order to facilitate processing of the constituents into a homogeneously mixed mixture by decreasing viscosities and/or melting of individual constituents.

The homogeneously mixed mixture of the constituents of the acoustic damping material can subsequently be processed into a form of a shaped article by using any conventional techniques, such as extruding, blow-molding, injection molding, compression molding, calendering, or hot-pressing techniques.

Step (ii) is preferably conducted by providing the radiation curable adhesive composition in a molten state and applying the molten adhesive composition to the first surface of the damping layer using any conventional technique, for example, by using slot die coating, roller coating, extrusion coating, calendar coating, or spray coating.

The adhesive film is then subjected to a dosage of radiation, which may be supplied by using one or more lamps, such as LED lamps. Required dosage of the radiation depends mainly on the thickness of the adhesive film, desired crosslinking degree, and detailed composition of the adhesive.

The dosage of radiation energy supplied to the adhesive film can be controlled by adjusting the intensity of the radiation and exposure time. The intensity of the radiation can be controlled by adjusting the power supplied to the respective lamps and the distance between the lamps and the surface of the adhesive film.

The optional step (iv) can be conducted by using any conventional technique known to the skilled person, for example, by punch or die cutting.

Another subject of the present invention is a method for providing a damped system comprising steps of:
I) Providing a vibration and noise damping element (1) as discussed above and
II) Contacting the outer major surface of the adhesive layer (4) with a noise emitting surface (7) of a substrate (6) and applying sufficient pressure to form an adhesive bond between the first surface (3) of the damping layer (2) and the noise emitting surface (7).

The term “outer major surface” of the adhesive layer refers to the major surface of the adhesive layer on the side opposite to the side of the damping layer.

The substrate having a noise emitting surface can be any type of shaped article, such as a panel, a sheet, or a film, composed, for example, of metal, plastic, or fiber reinforced plastic.

According to one or more embodiments, the noise emitting surface is an oily surface, preferably an oily metal surface.

According to one or more embodiments, the substrate is part of a structure of an automotive vehicle or a white good.

Still another subject of the present invention is a damped system comprising a substrate (6) having a noise emitting surface (7) and a vibration and noise damping element (1) as discussed above, wherein least a portion of the first surface (3) of the damping layer (2) is adhesively bonded to the noise emitting surface (7) via the adhesive layer (4), wherein said substrate (6) having the noise emitting surface (7) is preferably part of a structure of an automotive vehicle or a white good.

A cross-section of a vibration damped system is shown in FIG. 2.

According to one or more embodiments, the substrate having the noise emitting surface is part of a structure of an automotive vehicle or a white good.

### Examples

The followings compounds and products shown in Table 1 were used in the examples.

TABLE 1

| | | |
|---|---|---|
| SP11 | Styrene-isoprene-styrene linear triblock | |
| | copolymer having a polystyrene content of | |
| | 20-30 wt.-% | |
| SP12 | Styrene-isoprene-styrene block copolymer | |
| | having a polystyrene content of 12-18 wt.-% | |
| SP2 | Styrene-butadiene-styrene linear triblock | |
| | copolymer having a polystyrene content of | |
| | 30-40 wt.-% | |
| TR | Aliphatic C5 hydrocarbon resin, Ring & Ball | |
| | softening point (ASTM E 28) 95-105° C. | |
| PI | Phenylbis(2,4,6- | Songcure ® CS 819 |
| | trimethylbenzoyl)phosphineoxide | |
| CA1 | Polyether-based tri-functional polythiol | Thiocure ® 332 |
| CA2 | Hexafunctional Polythiol | Thiocure ® 360 |
| CA3 | Tetrafunctional polythiol | Thiocure ® 340 |
| CA4 | Polyether-based tri-functional polythiol | Thiocure ® 333 |
| PL | Naphthenic process oil, viscosity at 140° C. | |
| | 10-20 cSt | |
| LR | Butadiene homopolymer based liquid rubber | Kuraray ® LBR-361 |
| Antioxidant | Tetrakis[methylene-3-(3,5-di-tert-butyl-4- | |
| | hydroxyphenyl)propionate] | |
| | methane | |

### Preparation of Radiation Curable Adhesive Compositions

The plasticizer (PL) was first added to a mixer and heated to a temperature of 180° C. Then the tackifying resin (TR) and polymers (SP1, SP2) were then added, and the mixing was continued at a temperature of above 160° C. Finally, the photoinitiator (PI) and the crosslinking agent (CA) were added to the mixer and the mixing was continued until a homogeneously mixed mixture was obtained.

### Heat Resistance (Heat Stability Under Static Load)

A bitumen-based damping layer (SikaDamp®-139) was coated with the radiation curable adhesive composition and cut into test specimens having a width of 7 cm and length of 16 cm. The adhesive composition was coated with a coating weight of 50 g/m² using a hotmelt coating machine. After the application, the adhesive films were cured using IST HANDCURE system having an emission spectrum of 365-415 nm.

The obtained self-adhering bitumen-based damping samples were bonded to samples of EPD (electrophoretic deposition) steel sheets. A test specimen obtained by bonding a sample the bitumen-based damping layer to EDP steel sheet using a double-sided adhesive tape (S-4705 MF, from ATP) was used as a reference example. The double-sided adhesive tape had two layers of acrylic pressure sensitive adhesive having a coating weigh of 50 g/m².

The test specimens were suspended vertically from one end on a metal hook and placed in an oven. In the heat stability measurement, the test specimens were thermally treated at a temperature of 160° C. for 30 minutes. The result of the heat resistance test was recorded as “pass” if a bond failure did not occur before the end of the heat treatment.

The constituents of the tested adhesive compositions and the length of the radiation treatment required to pass the heat resistance test are shown in Table 2 below.

### Roller Peel Strengths

An aluminum foil with a thickness of 0.15 mm was first coated with the tested radiation curable adhesive composition. The adhesive film was either left non-cured or radiation cured for 6 seconds using the IST HANDCURE system having an emission spectrum of 365-415 nm.

Sample stripes having a width of 30 mm were cut from of the adhesive coated aluminum foil and adhered with length of ca. 12 cm to an EPD steel sheet and rolled over with a standard FINAT roller twice in both directions. The composite test specimens were stored for 30 minutes at normal room temperature (RT) or at 160° C. before measuring of the peel strength. The roller peel strengths were measured at a peeling angle of 90° and at a constant cross beam speed of 100 mm/min over a length of 10 cm. The resulting peel strength was recorded as force per width of the substrate (N/cm).

### Initial Tack

The initial tack was determined with aluminum foils having a film of the tested radiation cured adhesive composition.

The aluminum foils were fixed to Anton Paar MCR 302 device using the software Rheocompass V1.30 and a plate geometry with a diameter of 8 mm. The geometry was moved down with constant speed of 10 μm/s until a constant normal force of 1 N was reached. Then the measuring system was moved upwards from the sample with a constant removal speed of 20 μm/s. Each sample is measured 5 times and the average value of force minimum was recorded.

TABLE 2

| Compositions [wt.-%] | *Ref-1 | Ex-1 | Ex-2 | Ex-3 | Ex-4 | Ex-5 | Ex-6 |
|---|---|---|---|---|---|---|---|
| SP11 | | 10.00 | 10.00 | 10.00 | 10.00 | 10.00 | — |
| SP12 | | — | — | — | — | — | 30.40 |
| SP2 | | 20.00 | 20.00 | 20.00 | 20.00 | 20.00 | — |
| TR | | 37.75 | 37.75 | 37.75 | 37.75 | 47.75 | 53.30 |
| PI | | 1.00 | 1.00 | 1.00 | 1.00 | 1.00 | 1.00 |
| CA1 | | 1.00 | — | — | — | — | — |
| CA2 | | — | 1.00 | — | — | — | — |
| CA3 | | — | — | — | 1.00 | 1.00 | 2.00 |
| CA4 | | — | — | 1.00 | — | — | — |
| PL | | 30.00 | 30.00 | 30.00 | 30.00 | 20.00 | — |
| LR | | — | — | — | — | — | 13.05 |
| Antioxidant | | 0.25 | 0.25 | 0.25 | 0.25 | 0.25 | 0.25 |
| Total | | 100.00 | 100.00 | 100.00 | 100.00 | 100.00 | 100.00 |
| **Radiation curing time [s] | — | 30 | 4 | >240 | 6 | 6 | >150 |
| Heat resistance 160° C. 30 | pass | pass | pass | pass | pass | pass | pass |
| min | | | | | | | |
| Peel strength (30 min @RT) | 5 | — | — | — | — | — | — |
| without radiation curing | | | | | | | |
| [N/cm] | | | | | | | |
| Peel strength (30 min @160° C.) | 5 | — | — | — | — | — | — |
| without radiation curing | | | | | | | |
| [N/cm] | | | | | | | |
| Peel strength (30 min @RT) | n.a. | 0 | n.a. | n.a. | 1 | 7 | 4 |
| 6 s radiation curing [N/cm] | | | | | | | |
| Peel strength (30 min @160° C.) | n.a. | 2 | n.a. | n.a. | 1 | 11 | 10 |
| 6 s radiation curing | | | | | | | |
| [N/cm] | | | | | | | |
| Initial tack [N] | −2.0 | −0.7 | −0.2 | n.a. | n.a. | −5.6 | −1.9 |

*S-4705 MF (from ATP)
**Curing time required to pass heat resistance test

1. A radiation curable adhesive composition comprising:
a) At least one styrene-based polymer SP,
b) At least one tackifying resin TR,
c) At least one photoinitiator PI, and
d) At least one crosslinking agent CA,
wherein the at least one photoinitiator PI can be activated with irradiation having a wavelength of 365-500 nm to initiate the curing reactions of the adhesive composition.

2. The radiation curable adhesive composition according to claim 1, wherein the at least one photoinitiator PI can be activated with irradiation having a wavelength of 365-475 nm, to initiate the curing reactions of the adhesive composition.

3. The radiation curable adhesive composition according to claim 1, wherein the at least one crosslinking agent CA has at least three thiol groups, and/or a number average molecular weight (Mₙ) determined by gel permeation-chromatography using polystyrene as standard of 150-1500 g/mol.

4. The radiation curable adhesive composition according to claim 1 comprising 10-50 wt.-%, based on the total weight of the adhesive composition, of the at least one styrene-based polymer SP.

5. The radiation curable adhesive composition according to claim 1 comprising:
a) 10-50 wt.-%, of the at least one styrene-based polymer SP,
b) 15-65 wt.-%, of the at least one tackifying resin TR,
c) 0.25-5 wt.-%, of the at least one photoinitiator PI, and
d) 0.05-5 wt.-%, of the at least one crosslinking agent CA, all proportions being based on the total weight of the adhesive composition.

6. The radiation curable radiation curable adhesive composition according to claim 1, wherein the at least one styrene-based polymer SP is selected from styrene-isoprene-styrene (SIS) block copolymer, styrene-butadiene-styrene (SBS) block copolymer, styrene-isoprene-butadiene-styrene block copolymer (SIBS), and styrene-butadiene rubber (SBR).

7. The radiation curable adhesive composition according to claim 1, wherein the at least one styrene-based polymer SP comprises at least one styrene-isoprene-styrene block copolymer SP1 and/or at least one styrene-butadiene-styrene block copolymer SP2.

8. The radiation curable adhesive composition according to claim 1, wherein the at least one tackifying resin TR has a softening point measured by a Ring and Ball method according to DIN EN 1238:2011 standard in the range of 65-185° C., preferably 75 175° C. and/or a number average molecular weight (Mₙ) determined by gel permeation-chromatography using polystyrene as standard of 150-5000 g/mol.

9. The radiation curable adhesive composition according to claim 1 further comprising:
e) At least one plasticizer PL.

10. The radiation curable adhesive composition according to claim 1 further comprising:
f) At least one liquid rubber LR.

11. An at least partially cured adhesive obtained by subjecting a mass of the radiation curable adhesive composition according to claim 1 to radiation having a wavelength in the range of 365-500.

12. A method for producing an at least partially cured adhesive comprising steps of:
i. Providing a mass of the radiation curable adhesive composition according to claim 1 and
ii. Subjecting the mass to radiation having a wavelength in the range of 365-500 nm, to initiate the curing reactions of the radiation curable adhesive composition.

13. A vibration and noise damping element comprising:
i) A damping layer having a first surface and a second surface and,
ii) An adhesive layer composed of the at least partially cured adhesive according to claim 11 and covering at least a portion of the first surface of the damping layer,
wherein the damping layer comprises or is composed of an acoustic damping material comprising:
A bitumen component BC or a polymer component PC,
At least one hydrocarbon resin HR,
Optionally at least one wax W,
Optionally at least one plasticizer PL, and
At least 25 wt.-%, based on the total weight of the acoustic damping material, of at least one solid particulate filler F.

14. The element according to claim 13, wherein the damping layer has a maximum thickness of 0.5-15 mm, and/or a mass per unit area of 1-5 kg/m².

15. A method for producing a vibration and noise damping element according to claim 13, the method comprising steps of:
I. Providing a damping layer as defined in claim 13,
II. Providing a film of the radiation curable adhesive composition on a first surface of the damping layer,
III. Subjecting the adhesive film to radiation having a wavelength in the range of 365-500 nm, to effect at least partial curing of the radiation curable adhesive composition, and
Optionally cutting the element obtained from step (iii) to pre-determined dimensions, such as length and/or width.

16. The method for providing a damped system comprising steps of:
I) Providing a vibration and noise damping element according to claim 13 and
II) Contacting the outer major surface of the adhesive layer with a noise emitting surface of a substrate and applying sufficient pressure to form an adhesive bond between the first surface of the damping layer and the noise emitting surface.

17. A damped system comprising a substrate having a noise emitting surface and a vibration and noise damping element according to claim 13, wherein least a portion of the first surface of the damping layer is adhesively bonded to the noise emitting surface via the adhesive layer, wherein said substrate having the noise emitting surface is part of a structure of an automotive vehicle or a white good.
